(19) United States
(12) Patent Application Publication
(10) Pub. No.: US 2008/0217821 A1
(43) Pub. Date: Sep. 11, 2008

(54) Welding Method by Means of Electromagnetic Radiation

(76) Inventors: Rainer Goring, Borken (DE); Martin Wielputz, Mainz (DE); Franz-Erich Baumann, Dulmen (DE); Karl Kuhmann, Dulmen (DE); Sylvia Monsheimer, Haltern am See (DE)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/089,809

(22) PCT Filed: Aug. 11, 2006
(86) PCT No.: PCT/EP06/65253

§ 371 Date: Apr. 10, 2008

(30) Foreign Application Priority Data
Nov. 24, 2005 (DE) 10 2005 056 286.8

(51) Int. Cl. H05B 6/00

(52) U.S. Cl. 264/482

(57) ABSTRACT

Two shaped articles A and B which are not directly weldable to one another can be welded to one another with the aid of a film C if the material of the first surface of this film is compatible with the material of the shaped article A and the material of the second surface of this film is compatible with the material of the shaped article B and if either the film C or a surface region in contact therewith absorbs electromagnetic radiation. The welding is carried out by brining the first surface of the film C into contact with the shaped article A and the second surface of the film C into contact with the shaped article B and inputting electromagnetic radiation.

The invention relates to a method for welding shaped articles by means of a film which may comprise one layer or a plurality of layers with the aid of electromagnetic radiation.

Shaped plastic articles can be bonded to one another by a very wide range of plastic welding methods, for example by high-frequency welding, thermal impulse welding, thermal contact welding or heated wedge welding or with the aid of electromagnetic radiation, such as laser light, IR or microwave radiation. In laser transmission welding, a laser-transparent part to be joined and a laser-absorbing joining partner are usually used. The laser radiation passes through the transmitting body and strikes the adjacent absorbing molding which melts as a result of the local heating. However, the laser beam which passes through the transmitting part to be joined should not penetrate too deeply into the absorbing joining partner during joining but should lead to melting of the absorbing shaped article in the surface regions themselves. This results in an advantageous, local conversion of the laser beam into heat within the joining zone. The expanding melt touches the transmitting joining partner and also melts it locally. Contact pressure supports the formation of the joint. The heat is introduced in a targeted manner and cannot escape prematurely to the outside. Thermoplastics in the unfilled state are very substantially transparent to the laser light at wavelengths which are usually used for laser transmission welding. An advantage over the other welding methods is the very good optical appearance of the joint and the locally limited heating of the joining zone. The same applies to welding by means of IR radiation or other electromagnetic radiation.

It is already known that two shaped articles which are laser-transparent can be welded to one another with the aid of an intermediate laser-absorbing film (WO 00/20157; WO 02/38677; F. Krause et al., “Mehr Freiheiten bei der Farbwahl” [More freedom in the choice of color], Kunststoffe 10/2003, pages 196-199). However, those processes in which two shaped articles which cannot be directly welded to one another owing to incompatibility are used were not known.

A method for the production of laser-welded composite shaped articles in which two shaped plastic articles A and B are welded to one another by means of a further shaped article C is furthermore known, the latter containing a material layer C1 transmitting laser radiation and a material layer C2 absorbing laser radiation. The layer C2 overlaps the shaped articles A and B and is bonded to these in the overlapping regions. However, composite articles of the geometry desired according to the invention are not obtained in this manner.

The object of the invention was to produce composite parts comprising two shaped articles incompatible with one another with the aid of electromagnetic radiation.

This object was achieved by a method which comprises the following steps:
a) provision of a shaped article A,
b) provision of a shaped article B whose material is incompatible with that of the shaped article A, at least one of the shaped articles A and B being transparent to electromagnetic radiation,
c) provision of a film C whose material of the first surface is compatible with the material of the shaped article A and whose material of the second surface is compatible with the material of the shaped article B, either the film C or a surface region in contact therewith absorbing electromagnetic radiation,
d) contacting of the first surface of the film C with the shaped article A and of the second surface of the film C with the shaped article B,
e) incidence of electromagnetic radiation with melting of the film C and
f) allowing the molten regions to cool.

In a possible embodiment of the invention, step d) is carried out in such a way that the film C is placed between the shaped articles A and B. In step e), the welding is then carried out simultaneously between A and C and between B and C.

In a further possible embodiment of the invention, the step d) is carried out in such a way that the film C is bonded beforehand to one of the shaped articles A and B, for example by lamination. In a special case thereof, the relevant shaped article is formed only on contact with the film. This can be effected by in-mold injection molding of a film placed in a mold with a molten molding material with formation of the shaped article and simultaneous composite formation with the film. This composite part is then brought into contact with another shaped article.

Other possible embodiments of the invention are, for example, the following:
one of the shaped articles A and B or the film C absorb or absorbs electromagnetic radiation in the wavelength range used, without an additive being necessary;
the absorption of the electromagnetic radiation is brought about by addition of an absorbing additive;
the additive which absorbs electromagnetic radiation is present in one of the shaped articles A and B, either over the entire shaped article, in a surface layer or directly on the surface. For example, this shaped article may consist completely or in the surface region of a molding material filled, for example, with carbon black. The film C then optionally contains only a little or no additive;
the additive which absorbs electromagnetic radiation is present in the film. This embodiment is preferred since here it is even better ensured compared with the abovementioned embodiment that a strong bond between the film and the two shaped articles forms on welding;
the film has one layer; in this case, it consists of a material which has strong adhesion to the materials of the two shaped articles;
the film has two layers; the material of one layer is optimized for adhesion to the shaped article A while the material of the other layer is optimized for adhesion to the shaped article B. The two film layers adhere strongly to one another;
the film has three layers, the material of the first outer layer being optimized for adhesion to the shaped article A and optionally being similar to the material of the shaped article A or identical with it; the same applies in context to the material of the second outer layer and the shaped article B. The two outer layers are bonded to one another by an adhesion promoter layer. In this way, substantial freedom in the pairing of materials is obtained. If required, the film may also comprise four or more layers; however, the production effort then increases. Furthermore, it must be ensured that the film is not too thick for melting over the entire thickness on irradiation;
the additive which absorbs electromagnetic radiation is present in all film layers. It is thus conceivable, but not necessary, for example in the case of a two- or three-layer film, for each layer to be formed from a molding material which contains such an additive. Different additives which absorb in different wavelength ranges are optionally present in different regions. This is advantageous particularly when regions at different depths are to be welded to one another from one side;
the additive which absorbs electromagnetic radiation is present in one layer or optionally in a plurality of layers but not in all layers of the film C. When the film is not too thick, a single absorbing layer is sufficient for allowing the film to melt over the entire thickness range on irradiation. In the case of a three-layer film, the additive may accordingly be present in one of the outer layers or in the middle layer or, for example, in one of the outer layers and in the middle layer;
in the simplest case, the composite part has the structure A/C/B. If both A and B are sufficiently transparent to the electromagnetic radiation, the radiation may be incident alternatively through A or through B;
the composite part contains more than one shaped article A, more than one shaped article B and/or more than one film C. Here, the shaped articles A or the shaped articles B or the films C may be different in shape, structure and composition. For example, composite parts of the structure A/C/B/C/A or A¹/C¹/B/C²/A² can be produced according to the invention. In these cases double welding is carried out by incidence from both sides.

These and other conceivable embodiments can be combined with one another if expedient.

Suitable shaped articles A and B are in particular injection-molded, extruded or blow-molded shaped articles or shaped articles produced by other methods of original forming or conversion technology (pressing, embossing, sintering, casting), including films and semi-finished products (panels, pipes, sheets, rods, etc.). These shaped articles can be produced by known methods. The shaped articles may also have a plurality of components, for example may have a multi-layer structure. At least one of these shaped articles must be laser-transparent.

The shaped articles are usually composed of thermoplastic polymers but may also be formed from thermosetting plastics.

Suitable thermoplastic polymers are all thermoplastics known to the person skilled in the art. Suitable thermoplastic polymers are described, for example, in Kunststoff-Taschenbuch, published by Saechtling, 25th edition, Hanser-Verlag, Munich, 1992, in particular chapter 4 and the references cited therein, and in Kunststoff-Handbuch, editors G. Becker and D. Braun, volumes 1 to 11, Hanser-Verlag, Munich, 1966 to 1996.

The following may be mentioned by way of example as suitable thermoplastics: polyoxyalkylenes, polycarbonates (PC), polyesters, such as polybutylene terephthalate (PBT) or polyethylene terephthalate (PET), polyolefins, such as polyethylene or polypropylene, poly(meth)acrylates, polyamides, vinylaromatic (co)polymers, such as polystyrene, high-impact polystyrene, such as HIPS, or ASA, ABS or AES polymers, polyarylene ethers, such as polyphenylene ether (PPE), polysulfones, polyurethanes, polylactides, halogen-containing polymers, polymers containing imido groups, cellulose esters, silicone polymers and thermoplastic elastomers. It is also possible to use blends of different thermoplastics as materials for the shaped plastic articles. These blends may be one-phase or multiphase polymer blends.

The shaped articles to be bonded to one another may consist of identical or different thermoplastics or thermoplastic blends.

Polyoxyalkylene homo- or copolymers, in particular (co)polyoxymethylenes (POM), and processes for their preparation are known per se to the person skilled in the art and are described in the literature. Suitable materials are commercially available, for example under the trade name Ultraform® (BASF AG). Very generally, these polymers have at least 50 mol % of repeating units —CH₂O— in the polymer main chain. The homopolymers are generally prepared by polymerization of formaldehyde or trioxane, preferably in the presence of suitable catalysts. Polyoxymethylene copolymers and polyoxymethylene terpolymers are preferred. Preferred polyoxymethylene(co)polymers have melting points of at least 150° C. and molecular weights (weight average) Mw in the range of from 5000 to 200 000, preferably from 7000 to 150 000, g/mol. Polyoxymethylene polymers whose end groups have been stabilized and which have C—C bonds at the chain ends are particularly preferred.

Suitable polycarbonates are known per se and are obtainable, for example, by interfacial polycondensation according to DE-B-13 00 266 or by reaction of biphenyl carbonate with bisphenols according to DE-A-14 95 730. A preferred bisphenol is 2,2-di(4-hydroxyphenyl)propane, generally referred to as bisphenol A. Suitable polycarbonates are commercially available under the trade name Lexan® (GE Plastics B. V., the Netherlands).

Suitable polyesters are likewise known per se and are described in the literature. They contain an aromatic ring in the main chain, which originates from an aromatic dicarboxylic acid. The aromatic ring may also be substituted, for example by halogen, such as chlorine or bromine, or by C₁-C₄-alkyl groups, such as methyl, ethyl, isopropyl or n-propyl or n-butyl, isobutyl or tert-butyl groups. The polyesters can be prepared by reacting aromatic dicarboxylic acids, their esters or other ester-forming derivatives thereof with aliphatic dihydroxy compounds in a manner known per se. Naphthalenedicarboxylic acid, terephthalic acid and isophthalic acid and mixtures thereof may be mentioned as preferred dicarboxylic acids. Up to 30 mol % of the aromatic dicarboxylic acids can be replaced by aliphatic or cycloaliphatic dicarboxylic acids, such as adipic acid, azelaic acid, sebacic acid, dodecanedioic acid and cyclohexanedicarboxylic acid. Among the aliphatic dihydroxy compounds, diols having 2 to 6 carbon atoms, in particular 1,2-ethanediol, 1,4-butanediol, 1,6-hexanediol, 1,4-hexanediol, 1,4-cyclohexanedimethylol and neopentyl glycol or mixtures thereof are preferred. Polyalkylene terephthalates which are derived from alkanediols having 2 to 6 carbon atoms may be mentioned as particularly preferred polyesters. Among these, polyethylene terephthalate (PET), polyethylene naphthalate, polybutylene naphthalate and polybutylene terephthalate (PBT) are particularly preferred.

Suitable polyolefins are primarily polyethylene and polypropylene and copolymers based on ethylene or propylene, and optionally also with higher α-olefins. Polyolefins are also to be understood as meaning ethylene/propylene elastomers and ethylene/propylene terpolymers.

In particular, polymethyl methacrylate (PMMA) and copolymers based on methyl methacrylate with up to 40% by weight of further copolymerizable monomers, such as n-butyl acrylate, tert-butyl acrylate or 2-ethylhexyl acrylate, as are obtainable, for example, under the names Lucryl® (BASF AG) or Plexiglas® (Röhm GmbH), may be mentioned among the poly(meth)acrylates. In the context of the invention, impact-modified poly(meth)acrylates and blends of poly(meth)acrylates and SAN polymers which are impact-modified with polyacrylate rubbers (e.g. the commercial product Terlux® from BASF AG) are also to be understood thereby.

In the context of the present invention polyamides are to be understood as meaning all known polyamides, including polyetheramides and polyether block amides and blends thereof. Examples of these are polyamides which are derived from lactams having 7 to 13 ring members, such as polycaprolactam, polycapryllactam and polylaurolactam, and polyamides which are obtained by reacting dicarboxylic acids with diamines. The polyamides may also be completely aromatic or partially aromatic; the latter are usually referred to as PPA.

Dicarboxylic acids which may be used are alkane dicarboxylic acids having 6 to 14, in particular 6 to 12, carbon atoms and aromatic dicarboxylic acids. Adipic acid, azelaic acid, sebacic acid, dodecanedioic acid (=decanedicarboxylic acid) and terephthalic and/or isophthalic acid may be mentioned as acids here.

Particularly suitable diamines are alkanediamines having 6 to 12, in particular 6 to 8, carbon atoms and m-xylylenediamine, di(4-aminophenyl)methane, di(4-aminocyclohexyl)methane, 2,2-di(4-aminophenyl)propane or 2,2-di(4-aminocyclohexyl)propane.

Preferred polyamides are polyhexamethyleneadipamide (PA66), polyhexamethylenesebacamide (PA610), polyhexamethylenedecanedicarboxamide (PA612), polycaprolactam (PA6), copolyamides 6/66, in particular having a proportion of from 5 to 95% by weight of caprolactam units, and polylaurolactam (PA12) and PA11, and additionally copolyamides based on caprolactam, terephthalic acid and hexamethylenediamine or based on terephthalic acid, adipic acid and hexamethylenediamine.

In addition, polyamides which are obtainable, for example, by condensation of 1,4-diaminobutane with adipic acid at elevated temperature may also be mentioned (PA46). Preparation processes for polyamides of this structure are described, for example in EP-A 0 038 094, EP-A 0 038 582 and EP-A 0 039 524.

Further examples are polyamides which are obtainable by copolymerization of two or more of the abovementioned monomers, or blends of a plurality of polyamides, the blend ratio being arbitrary.

The following nondefinitive list contains said polyamides and further polyamides in the context of the invention (the monomers are stated in brackets): PA46 (tetramethylenediamine, adipic acid), PA66 (hexamethylenediamine, adipic acid), PA69 (hexamethylenediamine, azelaic acid), PA610 (hexamethylenediamine, sebacic acid), PA612 (hexamethylenediamine, decanedicarboxylic acid), PA613 (hexamethylenediamine, undecanedicarboxylic acid), PA614 (hexamethylenediamine, dodecanedicarboxylic acid), PA1212 (1,12-dodecanediamine, decanedicarboxylic acid), PA1313 (1,13-diaminotridecane, undecanedicarboxylic acid), PA MXD6 (m-xylylenediamine, adipic acid), PA TMDT (trimethylhexamethylenediamine, terephthalic acid), PA4 (pyrrolidone), PA6 (ε-caprolactam), PA7 (ethanolactam), PA8 (capryllactam), PA9 (9-aminopelargonic acid), PA 11 (11-aminoundecanoic acid), PA12 (laurolactam). These polyamides and their preparation are known. The person skilled in the art can find details of their preparation in Ullmanns Encyklopädie der Technischen Chemie, 4th Edition, Vol. 19, pages 39-54, Verlag Chemie, Weinheim 1980, and Ullmanns Encyclopedia of Industrial Chemistry, Vol. A21, pages 179-206, VCH Verlag, Weinheim 1992, and Stoeckhert, Kunststofflexikon, 8th Edition, pages 425-428, Hanser Verlag Munich 1992 (keyword “Polyamide” [Polyamides] and the following).

Further suitable thermoplastic materials are vinylaromatic (co)polymers. The molecular weight of these polymers known per se and commercially available is in general in the range of from 1500 to 2 000 000, preferably in the range of from 70 000 to 1000 000 g/mol.

Vinylaromatic (co)polymers of styrene, chlorostyrene, α-methylstyrene and p-methylstyrene may be mentioned here merely as being typical; the composition may also comprise minor portions (preferably not more than 20, in particular not more than 8% by weight) of comonomers such as (meth)acrylonitrile or (meth)acrylates. Particularly preferred vinylaromatic (co)polymers are polystyrene, styrene/acrylonitrile copolymers (SAN) and high-impact polystyrene (HIPS). Of course, it is also possible to use blends of these polymers. The preparation can also be effected by the process described in EP-A-0 302 485.

Furthermore, ASA, ABS and AES polymers (ASA=acrylonitrile/styrene/acrylate, ABS=acrylonitrile/butadiene/styrene, AES=acrylonitrile/EPDM rubber/styrene) are particularly preferred. These impact-resistant vinylaromatic polymers contain at least one elastomeric graft polymer and a thermoplastic polymer (matrix polymer). In general, a styrene/acrylonitrile polymer (SAN) is relied on as matrix material. Preferably used graft polymers are those which contain, as the rubber, a diene rubber based on dienes, such as, for example butadiene or isoprene (ABS), an alkyl acrylate rubber based on alkyl esters of acrylic acid, such as n-butyl acrylate and 2-ethylhexyl acrylate and EPDM rubber based on ethylene, propylene and a diene or blends of these rubbers or rubber monomers.

The preparation of suitable ABS polymers is described in detail, for example in DE-A 100 26 858 or in DE-A 197 28 629. For the preparation of ASA polymers, for example, it is possible to consult EP-A 0 099 532. Information on the preparation of AES polymers is disclosed, for example, in U.S. Pat. No. 3,055,859 or in U.S. Pat. No. 4,224,419.

Polyarylene ethers are preferably to be understood as meaning polyarylene ethers per se, polyarylene ether sulfides, polyarylene ether sulfones or polyarylene ether ketones. The arylene groups thereof may be identical or different and, independently of one another, may be an aromatic radical having 6 to 18 carbon atoms. Examples of suitable arylene radicals are phenylene, biphenylene, terphenylene, 1,5-naphthylene, 1,6-naphthylene, 1,5-anthrylene, 9,10-anthrylene or 2,6-anthrylene. Among these, 1,4-phenylene and 4,4′-biphenylene are preferred. These aromatic radicals are preferably not substituted. However, they may carry one or more substituents. Suitable polyphenylene ethers are commercially available under the name Noryl® (GE Plastics B. V., the Netherlands).

The polyarylene ethers are known per se or can be prepared by methods known per se.

Preferred process conditions for the synthesis of polyarylene ether sulfones or ketones are described, for example, in EP-A 0 113 112 and EP-A 0 135 130. Suitable polyphenylene ether sulfones are commercially available, for example, under the name Ultrason® E (BASF AG), and suitable polyphenylene ether ketones under the name Victrex®.

Furthermore, polyurethanes, polyisocyanurates and polyureas are suitable materials for the production of the shaped plastic articles. Flexible, semirigid or rigid, thermoplastic or crosslinked polyisocyanate polyadducts, for example polyurethanes, polyisocyanurates and/or polyureas, are generally known. Their preparation is widely described and is usually effected by reacting isocyanates with compounds reactive toward isocyanates under generally known conditions. The reaction is preferably carried out in the presence of catalysts and/or auxiliaries.

Suitable isocyanates are the aromatic, arylaliphatic, aliphatic and/or cycloaliphatic organic isocyanates known per se, preferably diisocyanates.

For example, generally known compounds having a molecular weight of from 60 to 10 000 g/mol and a functionality with respect to isocyanates of from 1 to 8, preferably from 2 to 6 (functionality of about 2 in the case of thermoplastic polyurethanes), for example polyols, such as polyetherpolyols, polyesterpolyols and polyetherpolyesterpolyols having a molecular weight of from 500 to 10 000 g/mol and/or diols, triols and/or polyols having molecular weights of less than 500 g/mol, can be used as compounds reactive toward isocyanates. Polylactides, i.e. polymers of lactic acid, are known per se and can be prepared by processes known per se.

In addition to polylactide, it is also possible to use copolymers or block copolymers based on lactic acid and further monomers. In general, linear polylactides are used. However, it is also possible to use branched lactic acid polymers. For example, polyfunctional acids or alcohols may serve as branching agents.

For example, polymers of vinyl chloride may be mentioned as suitable halogen-containing polymers, in particular polyvinyl chloride (PVC), such as rigid PVC and flexible PVC, and copolymers of vinyl chloride, such as PVC-U molding materials.

Fluorine-containing polymers, in particular polytetrafluoroethylene (PTFE), tetrafluoroethylene/perfluoropropylene copolymers (FEP), copolymers of tetrafluoroethylene with perfluoroalkyl vinyl ether, ethylene/tetrafluoroethylene copolymers (ETFE), polyvinylidene fluoride (PVDF), polyvinyl fluoride (PVF), polychlorotrifluoroethylene (PCTFE) and ethylene/chlorotrifluoroethylene copolymers (ECTFE), are furthermore suitable.

Polymers containing imido groups are in particular polyimides, polyetherimides and polyamidoimides.

Suitable cellulose esters are, for example, cellulose acetate, cellulose acetobutyrate and cellulose propionate.

In addition, silicone polymers are also suitable as thermoplastics. Silicone rubbers are particularly suitable. These are usually polyorganosiloxanes which have groups capable of crosslinking reactions. Such polymers are described, for example, in Römpp Chemie Lexikon, CD-ROM version 1.0, Thieme Verlag Stuttgart 1995.

Finally, it is also possible to use the class of compounds which comprises the thermoplastic elastomers (TPE). TPE can be processed in the same way as thermoplastics but have elastomeric properties. TPE block copolymers, TPE graft copolymers and segmented TPE copolymers comprising two or more monomer building blocks are suitable. Particularly suitable TPE are thermoplastic polyurethane elastomers (TPE-U or TPU), styrene oligoblock copolymers (TPE-S), such as SBS (styrene/butadiene/styrene block copolymers) and SEBS (styrene/ethylene/butylene/styrene block copolymers, obtainable by hydrogenation of SPS), thermoplastic polyolefin elastomers (TPE-O), thermoplastic polyester elastomers (TPE-E), thermoplastic polyamide elastomers (TPE-A) and in particular thermoplastic vulcanizates (TPE-V). The person skilled in the art can find details of TPE in G. Holden et al., Thermoplastic Elastomers, 2nd Edition, Hanser Verlag, Munich 1996.

The shaped articles A and B can moreover contain customary additives and processing auxiliaries.

Suitable additives and processing auxiliaries are, for example, lubricants and mold release agents, rubbers, antioxidants, light stabilizers, antistatic agents, flameproofing agents or fibrous or pulverulent fillers or reinforcing agents and other additives or mixtures thereof.

Suitable lubricants and mold release agents are, for example, stearic acid, stearyl alcohol, stearates or stearamides, silicone oils, metal stearates, montan waxes and waxes based on polyethylene and polypropylene.

Suitable antioxidants (heat stabilizers) are, for example, sterically hindered phenols, hydroquinones, arylamines, phosphites, various substituted members of this group and mixtures thereof.

Suitable light stabilizers are, for example, various substituted resorcinols, salicylates, benzotriazoles, benzophenones and HALS (hindered amine light stabilizers).

Suitable antistatic agents are, for example, amine derivatives such as, N,N-bis(hydroxyalkyl)alkylamines or -alkyleneamines, polyethylene glycol esters or glyceryl mono- and distearates and mixtures thereof.

Suitable flameproofing agents are, for example, the halogen-containing compounds known to the person skilled in the art, alone or together with antimony trioxide, or phosphorus-containing compounds, magnesium hydroxide, red phosphorus or other customary compounds or mixtures thereof. These include, for example, the phosphorus compounds disclosed in DE-A 196 32 675 or the phosphorus compounds disclosed in Encyclopedia of Chemical Technology, Editors R. Kirk and D. Othmer, Vol. 10, 3rd edition, Wiley, New York, 1980, pages 340 to 420, such as phosphates, e.g. triaryl phosphates, such as triscresyl phosphate, phosphites, e.g. triaryl phosphites, or phosphonites. Phosphonites used are as a rule bis(2,4-di-tert-butylphenyl) phenyl phosphonite, tris(2,4-di-tert-butylphenyl) phosphonite, tetrakis(2,4-di-tert-butyl-6-methylphenyl) 4,4′-biphenylylenediphosphonite, tetrakis(2,4-di-tert-butylphenyl) 4,4′-biphenylylenediphosphonite, tetrakis(2,4-dimethylphenyl) 1,4-phenylylenediphosphonite, tetrakis(2,4-di-tert-butylphenyl) 1,6-hexylylenediphosphonite and/or tetrakis(3,5-dimethyl-4-hydroxyphenyl) 4,4′-biphenylylenediphosphonite or tetrakis(3,5-di-tert-butyl-4-hydroxyphenyl) 4,4′-biphenylylenediphosphonite.

Furthermore suitable are inorganic flameproofing agents based on hydroxides or carbonates, in particular of magnesium, inorganic and organic boron compounds, such as boric acid, sodium borate, boron oxides, sodium tetraphenylborate and tribenzyl borate, nitrogen-containing flameproofing agents, such as iminophosphoranes, melamine cyanurate and ammonium polyphosphates and melamine phosphate (cf. also Encyclopedia of Chemical Technology, ibid.). Mixtures with antidrip agents, such as Teflon or high molecular weight polystyrene, are furthermore suitable as flameproofing agents.

Carbon fibers or glass fibers in the form of woven glass fabrics, glass mats or glass rovings, chopped glass and glass spheres, particularly preferably glass fibers, may be mentioned as examples of fibrous or pulverulent fillers and reinforcing substances. The glass fibers used may comprise E-, A- or C-glass and are preferably treated with a size, for example based on epoxy resin, silane, aminosilane or polyurethane, and an adhesion promoter based on functionalized silanes. The incorporation of the glass fibers can be effected both in the form of short glass fibers and in the form of rovings.

Suitable particulate fillers are, for example, amorphous silica, whiskers, alumina fibers, magnesium carbonate (chalk), powdered quartz, mica, bentonites, talc, feldspar or in particular calcium silicates, such as wollastonite and kaolin.

The fibrous, pulverulent or particulate fillers and reinforcing substances are usually used in amounts of from 1 to 60 and preferably from 10 to 50% by weight, based on the shaped article.

Furthermore, the shaped articles A or B may contain colorants. Accordingly, the shaped articles A and B may be of the same color or of different colors.

The production of the shaped articles from the polymer molding materials, the additives, processing auxiliaries and/or colorants can be effected by mixing methods known per se, for example with melting in an extruder, Banbury mixer, kneader, roll mill or calender. However, the components can also be used “cold” and the pulverulent mixture or mixture consisting of granules is melted and homogenized only during processing.

The components, optionally with the additives, processing auxiliaries and/or colorants mentioned, are preferably mixed in an extruder or another mixing apparatus at temperatures of from 100 to 320° C. with melting of the thermoplastic polymer and are discharged. The use of an extruder is particularly preferred, especially of a co-rotating, closely intermeshing twin-screw extruder.

Alternatively, one of the two shaped articles may consist of a material which is not a plastic, for example of wood, metal (e.g. aluminum, magnesium, steel), ceramic or stone. The other shaped article is then transparent to electromagnetic radiation.

The material of shaped article A is incompatible with that of shaped article B. As a result of this, the two shaped articles cannot be directly welded since either no adhesion is achieved or the adhesion is insufficient.

The achievable adhesion is insufficient when, on professional welding of a shaped article A transparent to electromagnetic radiation to a shaped article B which contains an effective amount of an additive absorbing electromagnetic radiation, by incidence of electromagnetic radiation, a shaped article is obtained in which the tensile stress required for fracturing the weld joint (measured in the tensile test according to DIN EN ISO 527) is less than 2 N/mm², preferably not more than 1.5 N/mm² and particularly preferably not more than 1 N/mm².

In the case of the material for the film C, it is possible in principle to rely on the abovementioned thermoplastics or molding materials. With regard to the choice of material, the person skilled in the art can rely on a wide range of material pairs which are known to be compatible.

In general, the film is not more than 500 μm, not more than 400 μm, not more than 300 μm, not more than 250 μm or not more than 200 μm thick, while the minimum thickness is 10 μm, 15 μm, 20 μm, 25 μm or 30 μm.

Typical examples of suitable material combinations are the following:
a) A shaped article A comprising a commercially available polyamide molding material (for example, based on PA6, PA66, PA610, PA612, PA1010, PA11, PA12 or one of the polyamides mentioned further above) is bonded via a film which consists, for example, of a molding material based on a polypropylene grafted with maleic anhydride (for example Admer® QB 520E), to which, for example, a carbon black has been added as an additive, to a shaped article B comprising a commercially available polypropylene molding material. The adhesion achieved is acceptable.
b) Stronger bonding of the shaped articles A and B mentioned under a) is possible using an intermediate two-layer film whose layer adjacent to the shaped article A consists of a polyamide molding material to which, for example, carbon black has been added as an additive (most preferably based on the same polyamide as in the shaped article A) while the layer adjacent to the shaped article B consists of a molding material based on a polypropylene grafted with maleic anhydride (for example, Admer® QB 520E).
c) An additional gain in strength starting from b) is achieved using an intermediate three-layer film whose layer adjacent to the shaped article A consists of a polyamide molding material (most preferably based on the same polyamide as in the shaped article A), while the layer adjacent to the shaped article B consists of a commercially available polypropylene molding material; the two layers are bonded by an intermediate adhesion promoter layer based on a polypropylene grafted with maleic anhydride (for example Admer® QB 520E). The additive, e.g. carbon black, can alternatively be present in the polyamide layer, in the adhesion promoter layer and/or in the polypropylene layer.
   The three-layer film can—just like the two-layer film used under b)—be produced in a known manner, for example by coextrusion.
d) A further example is the welding of a shaped article comprising a PA12 molding material, for example a cover, the shaped article comprising a PBT molding material, for example a housing, with the aid of an intermediate two-layer film in which the layer (thickness e.g. 50 μm) adjacent to the PBT shaped article consists of a blend of PA12, PBT and compatibilizer (for example according to EP-A-0 509 211 or EP-A-1 065 048) and the layer (thickness e.g. 50 μm) adjacent to the PA12 shaped article consists of a PA12 molding material. The additive, e.g. carbon black, can alternatively be present in one or the other layer.

The additive absorbing electromagnetic radiation may be carbon black. Further suitable absorbing additives are bone charcoal, graphite, other carbon particles, copper hydroxide phosphate (KHP), dyes, pigments or metal powders. Interference pigments, as described, for example in EP-A-0 797 511, are also suitable; corresponding products are sold under the trade name Iriodin®. Also suitable are the additives described in WO 00/20157 and WO 02/38677 (e.g. ClearWeld®).

The following are also suitable: mica or mica pigments, titanium dioxide, kaolin, antimony(III) oxide, metal pigments, pigments based on bismuth oxychloride (e.g. Biflair series from Merck, high-luster pigment), indium tin oxide (nano ITO powder, from Nanogate Technologies GmbH or AdNano™ ITO from Degussa), AdNano™ zinc oxide (Degussa), lanthanum hexachloride and commercially available flameproofing agents which comprise melamine cyanurate or phosphorus, preferably phosphates, phosphites, phosphonites or elemental (red) phosphorus.

If the intention is to avoid any adverse effect on the intrinsic color, the absorber preferably comprises interference pigments, particularly preferably from the Iriodin LS series from Merck, or ClearWeld®.

Carbon black can be prepared by the furnace black process, the gas black process or the flame black process, preferably by the furnace black process. The primary particle size is from 10 to 100 nm, preferably from 20 to 60 nm, and the particle distribution may be narrow or broad. The BET surface area according to DIN 53601 is from 10 to 600 m²/g, preferably from 70 to 400 m²/g. The carbon black particles may have been subjected to an oxidative aftertreatment for establishing surface functionalities. They may be hydrophobic (for example Printex 55 or flame black 101 from Degussa) or hydrophilic (for example carbon black pigment FW20 or Printex 150 T from Degussa). They may have a high or low level of structuring; this describes the degree of aggregation of the primary particles. By using special conductive carbon blacks, the electrical conductivity of the components produced from the powder according to the invention can be established. Better dispersibility both in the wet and in the dry mixing processes can be utilized by using carbon blacks in bead form. The use of carbon black dispersions may also be advantageous.

Bone charcoal is a black mineral pigment which contains elemental carbon. It consists of from 70 to 90% of calcium phosphate and from 30 to 10% of carbon. The density is typically from 2.3 to 2.8 g/mol.

The absorber may also contain a mixture of organic and/or inorganic pigments, flameproofing agents or other colorants, each of which alone does not absorb or absorbs poorly at the wavelengths from 100 to 3000 nm which in combination absorb the input electromagnetic energy sufficiently well for use in the method according to the invention.

The concentration of the absorbing additive in the film or film layer is usually from 0.05 to 20% by weight, preferably from 0.1 to 5% by weight and particularly preferably from 0.2 to 1.5% by weight.

The welding with incidence of the electromagnetic radiation is carried out according to the prior art, advisably under contact pressure.

The electromagnetic radiation is not limited with regard to the frequency range. It may be, for example, microwave radiation, IR radiation or preferably laser radiation.

The laser radiation used in the method according to the invention generally has a wavelength in the range of from 150 to 11 000, preferably in the range from 700 to 2000 and particularly preferably in the range from 800 to 1100 nm.

In principle, all customary lasers are suitable, for example gas lasers and solid-state lasers, examples of gas lasers are (the typical wavelength of the emitted radiation is stated in brackets): CO₂ lasers (10 600 nm), argon gas lasers (488 nm and 514.5 nm), helium-neon gas lasers (543 nm, 632.8 nm, 1150 nm), krypton gas lasers (330 to 360 nm, 420 to 800 nm), hydrogen gas lasers (2600 to 3000 nm), nitrogen gas lasers (337 nm); examples of solid state lasers are (the typical wavelength of the emitted radiation is in brackets): Nd:YAG lasers (Nd³⁺:Y₃Al₅O₁₂) (1064 nm), high-power diode lasers (800 to 1000 nm), ruby lasers (694 nm), F₂ excimer lasers (157 nm), ArF excimer lasers (193 nm), KrCl excimer lasers (222 nm), KrF excimer lasers (248 nm), XeCl excimer lasers (308 nm), XeF excimer lasers (351 nm) and frequency-multiplied Nd:YAG lasers having wavelengths of 532 nm (frequency-doubled), 355 nm (frequency-tripled) or 266 nm (frequency-quadrupled).

The lasers used are usually operated at powers of from 1 to 200, preferably from 5 to 100 and in particular from 10 to 50 watt.

The energy densities of the lasers used are stated in the literature as so-called “energies input per unit of length” and, in the case of the present invention, are generally in the range of from 0.1 to 50 J/mm. The actual energy density is defined as power input/weld area produced. This value is equivalent to the ratio of energy input per unit of length to width of the weld seam produced. The actual energy densities of the lasers used are usually from 0.01 to 25 J/mm².

The energy density to be chosen depends not only on the reflection properties of the transparent body but inter alia also on whether the plastic shaped articles to be bonded contain fillers or reinforcing substances or other strongly laser-absorbing or laser-scattering substances. For polymers which have low reflection and contain no fillers or reinforcing substances, the energy densities used are usually from 1 to 20, in particular from 3 to 10 J/mm. For polymers which contain fillers or reinforcing substances, they are usually from 3 to 50, in particular from 5 to 20 J/mm.

Corresponding lasers which can be used in the method according to the invention are commercially available.

Particularly preferred lasers emit in the short-wave infrared range. Such particularly preferred lasers are solid-state lasers, in particular the Nd:YAG lasers (1064 nm) and high-powered diode lasers (from 800 to 1000 nm).

The laser radiation may be fixed in location (stationary) and the shaped articles to be bonded can be moved past the laser source. It is also possible for the shaped articles to be fixed in location (resting) and for the laser source to be moved past the shaped articles.

The laser source can be moved by moving the laser as a whole, only the laser head or only the laser radiation emerging from the laser by means of optical or optical-mechanical apparatuses. Such apparatuses may be, for example, lenses, mirrors, light-conducting cables, in particular optical fibers, and other apparatuses customary in laser technology, and combinations of said apparatuses. It is also possible for both laser source and shaped articles to move.

The speed of movement (“speed” below for short) of the laser source relative to the shaped articles is, for example, usually from 1 to 10 000 mm/s, preferably from 5 to 5000 and in particular from 50 to 1000 mm/s, in the case of contour welding.

Regarding the laser power and the speed, set upper and lower limits arise, inter alia, because the polymer material at the point of the shaped articles which is to be bonded decomposes if the laser power is too high or the speed is too low (thermal damage) and because a high-quality (i.e. durably strong and tight) weld seam is no longer possible if the laser power is too low or the speed is too high since the diffusion processes required for welding necessitate a certain heat action time.

It has proven advantageous in some cases to dry the shaped articles to be bonded prior to laser welding, in order to avoid weld seam defects due to vaporizing water.

The laser transmission welding can be carried out in various embodiments. Most important are mentioned by way of example: contour welding is a sequential welding process in which the laser beam is guided along a freely programmable seam contour or the component is moved relative to the fixed laser. The weld seam width can be varied considerably depending on the laser type, optical system and scattering by the laser-transparent shaped article and is typically in the range of from 0.6 to 5 mm.

Simultaneous welding: the radiation of individual high-powered diodes which is emitted linearly in the range along the seam contour to be welded. The melting and welding of the entire contour are thus effected at the same time (simultaneously).

Quasi-simultaneous or scan welding: this is a combination of contour and simultaneous welding. The laser beam is guided back and forth by means of a galvanometric mirror (scanner) at high speed along the weld contour. As a result, the region to be bonded gradually heats up and melts completely.

Mask welding: here, a linear laser beam is moved transversely over the parts to be bonded. By means of a mask present between laser and component, the radiation is cut off in a targeted manner and strikes the components only where they are to be welded. Very fine structures in the mask permit high resolutions and weld seam widths of only 10 μm.

The composite shaped articles obtained by the method according to the invention are in particular housings, containers, such as, for example, fuel tanks, packagings, utility articles, components, fixing elements, etc., of, for example, household appliances and electrical equipment or for the interior and exterior of automobiles, aircraft or ships.

The composite parts are distinguished, inter alia, in that the weld seams are liquid- and gas-impermeable.

The method according to the invention is suitable in particular also for the production of assembled shaped articles which contain further components. Such further components may be, for example, mechanical (including precision mechanical), electrical, electronic or optical, acoustic or other components comprising metals, glasses, ceramics, polymers, rubber or other materials.

The invention likewise relates to the composite parts produced according to the invention.

The weld strength achieved can be determined by means of a tensile test according to DIN EN ISO 527, either directly on the shaped article or on a part sawn out. The tensile strength required for fracturing the weld is preferably at least 2 N/mm² and preferably at least 3 N/mm², at least 4 N/mm², at least 5 N/mm², at least 6 N/mm², at least 7 N/mm², at least 8 N/mm², at least 9 N/mm² or at least 10 N/mm².

1: A method for the production of a composite part comprising at least two shaped articles which are not directly weldable to one another, which comprises:
a) providing a shaped article A,
b) providing a shaped article B whose material is incompatible with that of the shaped article A,
c) providing a film C whose material of the first surface is compatible with the material of the shaped article A and whose material of the second surface is compatible with the material of the shaped article B, either the film C or a surface region in contact therewith absorbing electromagnetic radiation,
d) contacting the first surface of the film C with the shaped article A and the second surface of the film C with the shaped article B,
e) applying electromagnetic radiation with melting of the film C and
f) allowing the molten regions to cool.

2: The method according to claim 1, wherein, in step d), the film is placed between the shaped articles A and B.

3: The method according to claim 1, wherein, in step d), the film C is bonded in a first stage to one of the shaped articles A and B.

4: The method according to claim 1, wherein the film C comprises two or more layers.

5: The method according to claim 1, wherein either the film C or a surface region in contact therewith contains an additive which absorbs electromagnetic radiation.

6: The method according to claim 5, wherein the additive which absorbs electromagnetic radiation is present in only one layer of a film C which comprises two or more layers.

7: The method according to claim 1, wherein the composite part contains more than one shaped article A, more than one shaped article B and/or more than one film C.

8: The method according to claim 1, wherein the thickness of the film C is from 10 to 500 μm.

9: The method according to claim 1, wherein the electromagnetic radiation is microwave radiation, IR radiation or laser radiation.

10: A composite part produced according to the method disclosed in claim 1.
